(19) United States
(12) Patent Application Publication
(10) Pub. No.: US 2025/0105602 A1
(43) Pub. Date: Mar. 27, 2025

(54) ELECTRICAL TRANSMISSION LINE REPAIR DEVICE AND METHOD OF USE

(71) Applicant: Classic Connectors, Inc., Trussville, AL (US)

(72) Inventors: Carl Russel Tamm, Trussville, AL (US); Jonathan Prinsloo, Odenville, AL (US); Michael Benedict, Trussville, AL (US)

(21) Appl. No.: 18/371,944

(22) Filed: Sep. 22, 2023

(51) Int. Cl. H02G 1/02

(52) U.S. Cl. CPC H02G 1/02

(57) ABSTRACT

A repair device for an electrical transmission line, including first and second end sections. The end sections have an elongated and electrically conductive frame with a clamp side and an entry side opposite the clamp side. The frame forms a C-channel including an upper and lower jaw which are spaced apart from each other to define a throat cavity, with an entrance slot defined on the entry side of the frame. The throat cavity is configured to receive an electrically conductive cable. The lower jaw includes a plurality of threaded openings extending therethrough and in communication with the throat cavity. Fasteners are threadedly engaged with the threaded openings to sandwich the electrically conductive cable against the lower jaw. An electrically conductive link member attaches the first and second end sections in a spaced apart orientation.

### BACKGROUND OF THE DISCLOSURE

### 1. Field of the Disclosure

The disclosure relates in general to electrical transmission line repair systems, and more particularly, to an electrical transmission line repair device that is configured to provide or restore mechanical and or/electrical integrity to electrical conductors as well as connectors, suspensions and the like. It will be understood that while transmission line is referred to herein, such shall encompass many types of electrical lines, including those that are often referred to as transmission and/or distribution lines and the like.

### 2. Background Art

Electrical transmission lines are well known in the art and include commonly known overhead types. Such types of electrical transmission lines comprise a core formed from metal members, as well as composite members having an outer conductive cladding extending around the core, typically made from an aluminum or aluminum alloy (although other conductors are likewise contemplated). A number of different configurations of such transmission lines as well as connectors, suspensions and clamps are disclosed in U.S. Pat. No. 7,794,291 issued to Goch, entitled “Electrical Transmission Line Repair Service,” the entire specification of which is hereby incorporated by reference.

The increasing power demands in recent decades has created a need to operate the electrical grid at an ever-increasing electrical current load. Consequently, these higher electrical current loads result in much higher temperatures and temperature fluctuations across the conductors and connectors of an electrical grid. These increased temperatures often exceed the safe operating temperature of modern transmission line connectors. Further, the associated temperature fluctuations cause thermodynamic expansion and contraction of the metals which comprise electrical conductors, thereby creating varying transmission line tension depending on current load and environmental factors. As a result of this expansion and contraction of the electrical conductors, repair devices known in the prior art have been unable to effectively maintain compression on the conductor being repaired or shunted.

In addition to the compression and tension issues faced by electrical conductors and transmission lines, it is also appreciated that the installation of repair devices is often done on energized lines that are suspended above the ground, often at great heights. Thus, the installation environment is quite difficult, and there remains a persistent need to allow for easier preparation and assembly of repair and maintenance devices. Particularly, there is a need to minimize the componentry so as to limit both the weight and structure of the device, which is often handled by users in rugged terrain and at a distance.

### SUMMARY OF THE DISCLOSURE

The disclosure is directed to electrical transmission line repair device, comprising a first end section, a second end section and at least one electrically conductive link member. The first end section includes a frame and a plurality of fasteners. The elongated and electrically conductive frame extends from an inner end to an outer end, and includes a clamp side and an entry side opposite the clamp side. The frame forms a C-channel including an upper jaw and lower jaw. The upper and lower jaws are spaced apart from each other to define a throat cavity, with an entrance slot defined on the entry side of the frame. The throat cavity is configured to receive an electrically conductive cable therealong. The lower jaw includes a plurality of threaded openings extending therethrough and in communication with the throat cavity. The plurality of fasteners are threadedly engaged with the threaded openings. Rotation of the fastener one of inwardly or outwardly directs the fastener toward or away from the upper jaw. The fasteners are structurally configured to sandwich the electrically conductive cable against the lower jaw, while allowing for elastic deformation of the frame about the clamp side. The second end section, in some configurations is like the first end section (while variations are contemplated. The at least one electrically conductive link member has a first end and a second end. The first end is attached to the first end section, and the second end attached to the second end section so that the first and second end sections are in a spaced apart orientation.

In some configurations, the frame of the first and second end sections further comprises a plurality of ribs and valleys positioned along the clamping side of both end sections.

In some configurations, one or both of the first and second end sections further comprise a fastener shield formed on the bottom side of the frame of both the first and second end sections. The fastener shield includes a first sidewall, second sidewall, inner end wall, and outer end wall, all of which collectively form a continuous outer surface, and which define a channel with a fastener bed along the bottom side surface of each frame.

In some configurations, the lower end of the outer surface of the fastener shield further comprises a lower fillet which creates an inwardly concave and smooth connection surface between the fastener shield and respective frame.

In some configurations, the fastener shield and frame are integrally formed with the ribs flowing into and being integrally formed with the second sidewall of the fastener shield.

In some configurations, the device further includes a second conductive link member having a first end and a second end. The first end is attached to the first end section, and the second end is attached to the second end section so that the first and second end sections are in a spaced apart orientation. The first conductive link member is affixed on the entry side of the first and second end sections. The second conductive link member is affixed on the clamp side of the first and second end sections.

In some configurations, each of the frames of the first and second end sections further comprise a landing flange extending from the entry side of the upper jaw.

In some configurations, one of the at least one link members is affixed to the landing flange of the first and second end sections.

In some configurations, a trough is formed at the coupling point between the at least one link member and the landing flanges of the first and second end sections.

In some configurations, one of the at least one link members further comprises an attachment hoop positioned along the length thereof.

In some configurations, the device further includes an entry flange extending from the entry side of the lower jaw of each of the first and second end sections.

In some configurations, the first and second end sections are substantially mirror images of each other.

In some configurations, at least some of the plurality of fasteners include a break away portion which breaks away from the fastener when a predetermined torque is reached.

In some configurations, the break away portion is configured to break away only after the frame has been elastically deformed so as to direct the jaws away from each other.

In some configurations, the elastic deformation is between 50% and 80%, and more preferably, between 60% and 77% of the elastic range of the first end and second end section.

In some configurations, each of the plurality of fasteners includes a biasing member so as to be biased against the conductor positionable within the first end section and the second end section.

In some configurations, the electrically conductive link is one of rigid and

flexible.

In another aspect of the disclosure, the disclosure is directed to a using an electrical transmission line repair device comprising the steps of: identifying a section of electrical conductor cable to be restored; providing the transmission line repair device comprising a first end section comprising an elongated and electrically conductive frame extending from an inner end to an outer end, and including a clamp side and an entry side opposite the clamp side, the frame forming a C-channel including an upper jaw and lower jaw, the upper and lower jaws being spaced apart from each other to define a throat cavity, with an entrance slot defined on the entry side of the frame, the lower jaw including a plurality of threaded openings extending therethrough and in communication with the throat cavity a plurality of fasteners threadedly engaged with the threaded openings wherein rotation of the fastener one of inwardly or outwardly directs the fastener toward or away from the upper jaw; with the second end section comprising a similar configuration, and at least one electrically conductive link member having a first end and a second end, the first end attached to the first end section, and the second end attached to the second end section so that the first and second end sections are in a spaced apart orientation; directing the cable into the throat cavity of each of the first and second end sections; tightening the fasteners of the first and second end sections to direct the fasteners toward the upper jaw to sandwich the electrical conductor cable therebetween.

In some configurations, the method further comprises the step of elastically deforming the first and second end sections through the step of tightening of the fasteners, to between 50% and 80% of the elastic range thereof.

In some configurations, the transmission line repair device further includes a first trough formed between the first end section and the first link member, and second trough formed between the second end section and the first link member. In such a configuration, the method further comprises the step of positioning the cable within the first trough; and positioning the cable within the second trough, wherein at least one of the steps of positioning occurring prior to the step of directing.

### BRIEF DESCRIPTION OF THE DRAWINGS

The disclosure will now be described with reference to the drawings wherein:

FIG. 1 of the drawings is a perspective view of the electrical transmission line repair device, showing, in particular, the first and second end sections, and the central linking assembly;

FIG. 2 of the drawings is a perspective view of the electrical transmission line repair device, showing, in particular, the clamp side and bottom side of the first and second end sections, and the central linking assembly;

FIG. 3 of the drawings is a perspective view of the electrical transmission line repair device, showing, in particular, the clamp side and top side of the first and second end sections, and the central linking assembly;

FIG. 4 of the drawings is a perspective view of the first end section of the present disclosure, showing, in particular, the entry side of the first end section;

FIG. 5 of the drawings is a perspective view of the second end section of the present disclosure, showing, in particular, the entry side of the first end section;

FIG. 6 of the drawings is a cross sectional view of the first end section of the present disclosure;

FIG. 7 of the drawings is a cross sectional view of the first end section of the present disclosure, showing, in particular, the frame of the first end section as well as a fastener;

FIG. 8 of the drawings is an orthogonal view of the electrical transmission line repair device, showing, in particular the top side of the first and second end sections, and the central linking assembly;

FIG. 9 of the drawings is an orthogonal view of the electrical transmission line repair device, showing, in particular the clap side of the first and second end sections, and the central linking assembly;

FIG. 10 of the drawings is an orthogonal view of the electrical transmission line repair device, showing, in particular the entry side of the first and second end sections, and the central linking assembly;

FIG. 11 of the drawings is an orthogonal view of the electrical transmission line repair device, showing, in particular the entry side of the first and second end sections, the fasteners, and the central linking assembly;

FIG. 12 of the drawings is a cross sectional view of the first end section of the present disclosure, showing, in particular, the frame of the first end section as well as a fastener and transmission line;

FIG. 13 of the drawings is an isometric view illustrating use of the electrical transmission line repair device to repair a transmission line; and

FIG. 14 of the drawings is an isometric view illustrating use of a hot stick to tighten fasteners.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

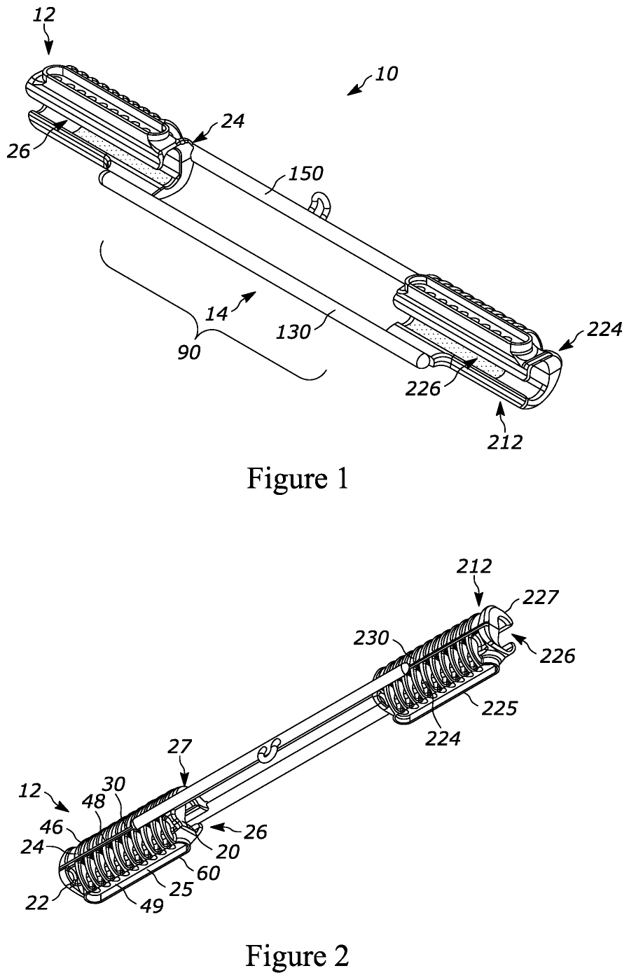

Referring now to the drawings and in particular to FIG. 1, the electrical transmission line repair device of the current application is shown generally at 10. The electrical transmission line repair device is typically well suited for use with distribution and transmission electrical conductors. That is, conductors that are up to 69,000V as well as voltages above 69,000V to 765,000V. Of course, the disclosure is not limited to use therewith, and other configurations are likewise contemplated for use in environments other than those mentioned herein.

The electrical transmission line repair device 10 is shown as including a first end section 12, and a second end section 212, and central linking assembly 14. The first and second end sections are joined together by way of the central linking assembly 14. The central linking assembly as shown is comprised of a first link member 130 and a second link member 150. As will be explained in greater detail below the first link member 130 being affixed to an entry side 26 of the first end section 12 and an entry side 226 of the second end section 212. The second link member 150 is affixed to a clamp side 24 of the first end section 12 at one end and affixed to a clamp side 224 of the second end section 212 at the other end. The central linking assembly 14 spans a linking distance 90 between the first and second end sections 12/212, and is understood to have various lengths as needed for various applications.

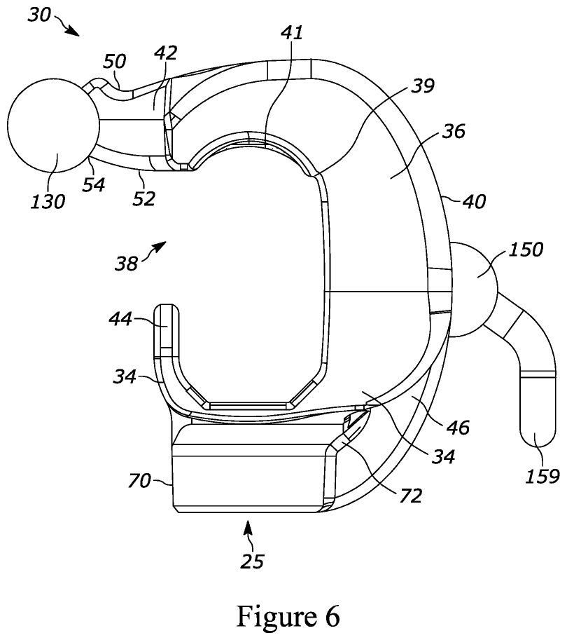

Referring now to FIGS. 2, 6-7, and 11, the first end section 12 includes frame 30, fastener shield 60 and fasteners 80. The first end section extends from an inner end 20 which, when assembled, is proximate to the central linking assembly 14 to an outer end 22 distally spaced therefrom. The first end section 12 further includes the clamp side 24, with an entry side 26 opposite to the clamp side, and defines a bottom side 25 and a top side 27 being opposite to the bottom side. The first end section 12 is also described herein with the understanding that in the configuration shown the second end section 212 is substantially identical to the first, although the first and second end sections are not required to be substantially identical in different embodiments. As such, similar structures on the second end section will have the same reference number as the first end section, augmented by 200.

Frame 30, as shown in FIGS. 4 and 6-7, comprises a throat cavity 32, a lower jaw 34, an upper jaw 36, an entrance slot 38, an outer surface 40 and a landing flange 42. The frame 30, in cross-section generally defines a C-shaped configuration, with an elongated channel defined through which a conductor can extend. The frame can be formed from a metal, such as aluminum (metal or alloy thereof), though other materials are likewise contemplated, and said materials are typically capable of conducting electricity. Additionally, the frame can be formed from a single casting, forging or the like, whereas in other configurations, the frame may be formed from multiple components that are attached together through various different processes known to one of skill in the art.

The lower jaw 34 and the upper jaw 36 oppose each other defining the throat cavity 32 therebetween. Lower jaw 34 further comprises an entry flange 44 which extends from the entry side of the lower jaw towards the upper jaw, and a plurality of fastener openings, such as fastener opening 49. Lower jaw 34, entry flange 44, and upper jaw 36 together define the throat cavity 32. The throat cavity is configured to receive an electrical transmission line or other electrically conductive wire, cable, rod, conductor, or device therealong. Entry flange 44 and the entry side of upper jaw 36 are spaced apart to form an entrance slot 38 which, as will be explained, allows access to the throat cavity 32. The lower jaw has a generally concave configuration which generally complements the conductor which is of a generally circular cross-sectional configuration.

The fastener openings 49 comprise a plurality of openings which extend along the frame and through the lower jaw 34. In the configuration shown, the fastener openings 49 are each threaded, and extend linearly between the inner and outer ends of the first end section 12. Further, the openings generally define an axis that is orthogonal to a longitudinal axis of the conductor that would be positioned within the throat cavity 32, with fasteners being generally perpendicular to a line tangent to the outer surface of the conductor positioned therewithin. Additionally, the openings are generally uniformly spaced apart. It is contemplated that the openings may be other than uniformly spaced apart and may be other than linearly disposed.

Upper jaw 36 is opposite from the lower jaw. The upper jaw has a generally concave inner surface which corresponds to the generally circular cross-sectional configuration of the conductor which will be positioned therealong. In some configurations the upper jaw may include a surface topography which aids in the retention of the conductor and generally precludes slidable movement between the conductor and the first end section.

The landing flange 42 extends from entry side 26 of the upper jaw 36, and forms an upper flange surface 50 and lower flange surface 52. Landing flange 42 couples frame 30 to the first link member 130 with a trough 54 being formed at the coupling point between the upper flange surface 50 and the first link member 130. In the configuration shown, the landing flange extends from the inner end toward the outer end terminating between short of the outer end. In other configurations, the landing flange may extend from the inner end to the outer end, or may be spaced apart from one or both of the inner and outer ends. In the configuration shown, and as will be explained further below, the landing flange length corresponds to the first side attachment region 136 of the first link member 130 along the first end section 12. Variations in length, of course, are contemplated. As will also be explained, the landing flange provides a location upon which a conductor can be initially introduced to the electrical transmission line repair device 10, whereupon introduction, the conductor can be aligned for passage into the throat cavity of the frame 30.

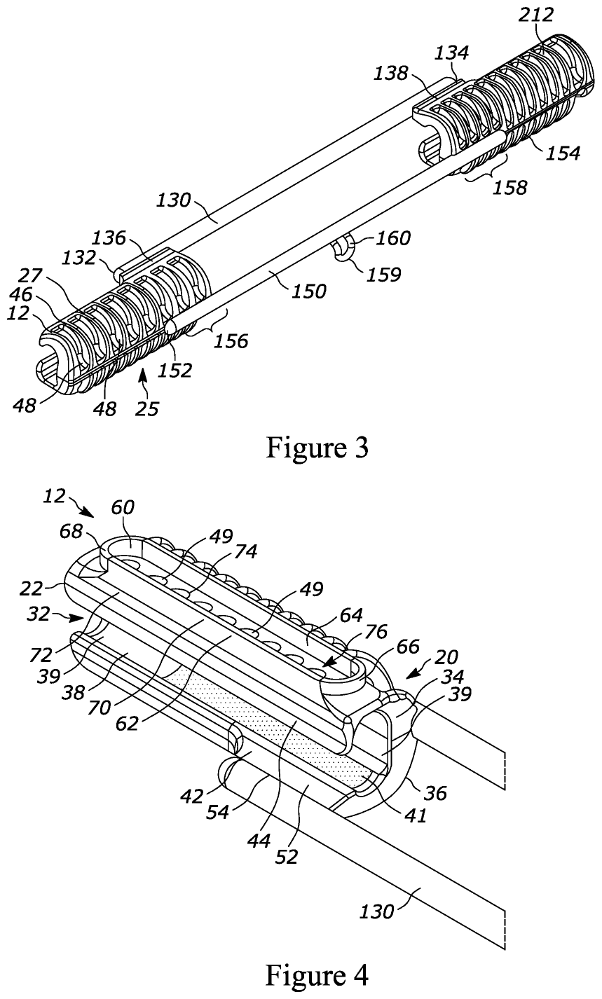

In the embodiment depicted, the outer surface 40 of frame 30 includes a plurality of ribs 46 and valleys 48, as is shown in FIGS. 2, 3, and 9. The ribs 46 are generally positioned about the clamping side 24 of the first end section and are generally spaced apart from each other in a substantially parallel arrangement between the inner end and the outer end of the first end section. The valleys 48 are defined between the spaced apart ribs 46. In the configuration shown, the ribs generally have a C-shaped cross-sectional configuration that mimics the C-shaped cross-sectional configuration of the entire end section. It will be understood that the shape of the ribs can be varied depending on the configuration, as well as the spacing and the corresponding shape of the valleys therebetween This configuration allows the “C”-shaped body of frame 30 to elastically deform when subjected to the clamping force of the fasteners 80 during operation, while precluding plastic deformation of the first end section, all while limiting the weight of the first end section. In some configurations, the ribs may be continuous so as to eliminate any valleys. However, with the inclusion, or formation of, the valleys, it is possible to reduce the weight of the transmission line repair device. In some configurations, the weight of the device is further reduced by the use of lightweight aluminum fasteners in all aspects of assembly and operation. This decreased weight, along with the substantial reduction in wind profile (as compared to products known in the industry), allows for the device to be used on transmission electrical lines as well as distribution electrical lines, which generally have lower line tension and are more affected or susceptible to sag from attached objects. The current design and weight reduction further decreases the ice accretion and allows for easier installation by electrical linemen and technicians.

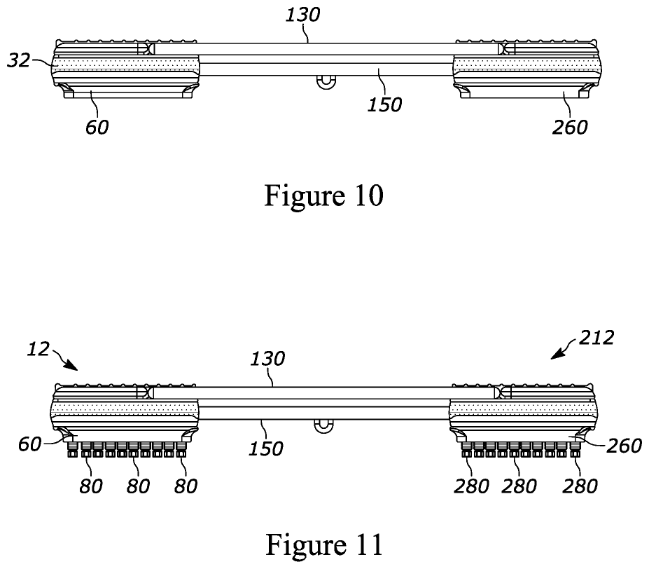

As shown in FIGS. 4 and 10-11, a fastener shield 60 is formed on the bottom side of frame 30 on the outer surface of the lower jaw of the frame 30. The fastener shield includes a first sidewall 62, second sidewall 64, inner end wall 66, and outer end wall 68, all of which define a channel 76 with a fastener bed 74 along the bottom side surface of frame 30. The first and second sidewalls are generally linear and mirror images of each other, with the inner end wall 66 and the outer end wall 68 comprising outwardly convex configurations. The first, second, inner, and outer sidewalls collectively form an continuous outer surface 70 which has a race track oval-like configuration due to the elongated sides and curved, outwardly convex inner and outer end walls. At a lower end of the outer surface 70 a lower fillet 72 creates an inwardly concave and smooth connection surface between the fastener shield 70 and frame 30. The outer surface 70 with convex and generally rounded corners, and the lower fillet being substantially continuous, and substantially free from sharp edges or protruding surfaces, helps to minimize electrical corona, which typically occurs between 138 kV and 169 kV, depending on the elevation above sea level (due to atmospheric density and pressure variables). In the configuration shown, the fastener shield 60 and the frame 30 are integrally formed, with the ribs flowing into and being integrally formed with the second sidewall 64. It will be understood that in some configurations, the fastener shield may comprise a separate component that is joined to the frame, preferably prior to assembly.

The fastener openings 49 extend through the fastener bed 74 of the fastener shield, with the outer surface 70 encircling the fasteners that are to be extended through the fastener openings 49. It will be understood that the height of the outer surface 70 generally is higher than the fasteners when the fasteners have been tightened to clamp the conductor positioned within the first end cavity. As such, the fasteners preferably remain within the channel that is formed by the outer surface in cooperation with the fastener bed. As will be understood, the outer surface 70 is sized so as to allow the insertion of tools within the channel to permit the operable engagement with and manipulation of the fasteners extending through the fastener openings.

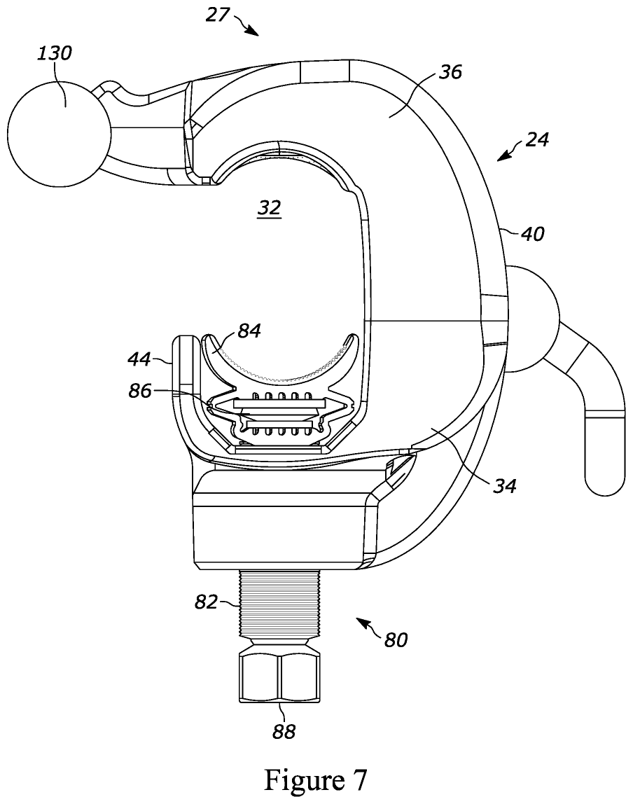

Fasteners 80, as shown in FIGS. 7 and 11, are configured to threadedly engage with the fastener openings 49, extend through lower jaw 34, and protrude into the throat cavity 32. In some configurations, the protruding portion of fasteners 80 is partially enclosed by lower jaw 34, and entry flange 44. In the configuration shown, fasteners 80 comprise a bolt 82, of the type that is described in U.S. Pat. No. 9,689,416, issued to Tamm, et al., and may be used in a manner similar to that which is disclosed in U.S. Pat. No. 9,343,823 issued to Tamm, et. al., Each of the foregoing patents are incorporated by reference herein, in their entirety. Fasteners 80 as shown additionally comprise a keeper 84, a torque limiting breakaway screw 88, and biasing member 86. In other embodiments the fasteners 80 may be simple threaded bolts, though other embodiments are contemplated. Furthermore, fasteners, such as the fasteners disclosed in U.S. Pat. No. 11,569,591 issued to Tamm, et al. are likewise contemplated. The foregoing patent is likewise incorporated by reference herein, in its entirety.

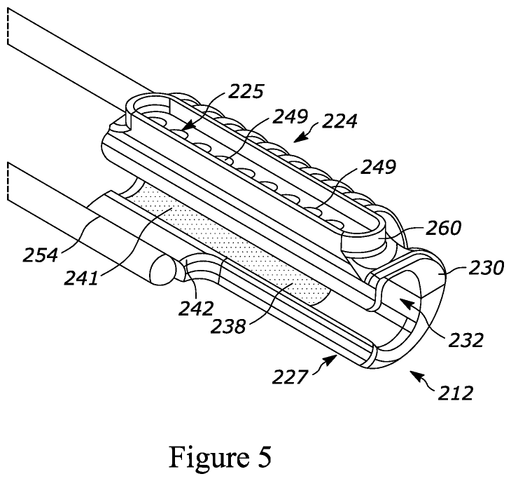

The second end section 212 is substantially identical to the first end section 12, as shown in FIGS. 2-5. That is, the second end section comprises a substantially mirror image of the first end section about the central linking assembly. The second end section includes frame 230, fastener shield 260 and fasteners, such as fasteners 280. Additionally, the structures that have similar functions are disclosed with the same reference numbers as those in first end section 12, augmented by 200.

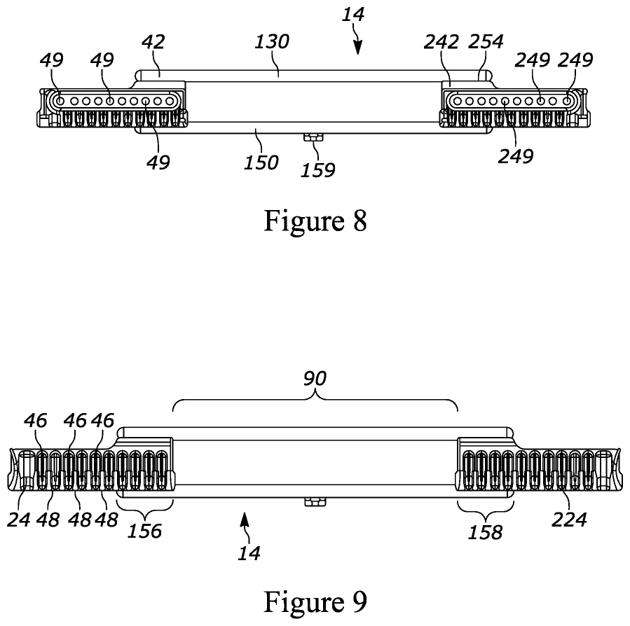

As shown in FIGS. 1 and 8-11, central linking assembly 14 comprises first link member 130 and second link member 150, the central linking assembly 14 spanning a linking distance 90 between the first end section 12 and second end section 212. First link member 130 includes a first end 132 coupled to landing flange 42 of the first end section 12, and a second end 134 coupled to landing flange 242 of the second end section 212. First link member 130 may be coupled to landing flanges 42/242 by metal welding or other preferably electrically conductive attachment means. It is understood that a first side attachment region 136 and second side attachment region 138, along with the corresponding landing flanges, may have varying lengths depending on the application and environment of the device 10.

Similarly, second link member 150 includes a first end 152 coupled to the clamp side 24 of first end section 12, and a second end 154 coupled to the clamp side 224 of the second end section 212. Second link member 150 may be coupled to first and second end sections 12/212 by metal welding or other preferably electrically conductive attachment means. In some embodiments, second link member 150 may be partially or fully incorporated into the first and second end sections 12/212, such that the member may be formed as part of the end sections. It is understood that a first side attachment region 156 and second side attachment region 158 may have varying lengths depending on the application and environment of the device 10.

In some embodiments, first link member 130 and second link member 150 may be affixed to alternate surfaces of the first and second end sections, such as on bottom side 25/225 or top side 27/227. Furthermore, it will be understood that the first and second link members are shown as comprising generally inflexible metal members, however, it is contemplated that members having a greater flexibility, such as, for example, cables formed in part or in whole from a plurality of metal strands, may be utilized.

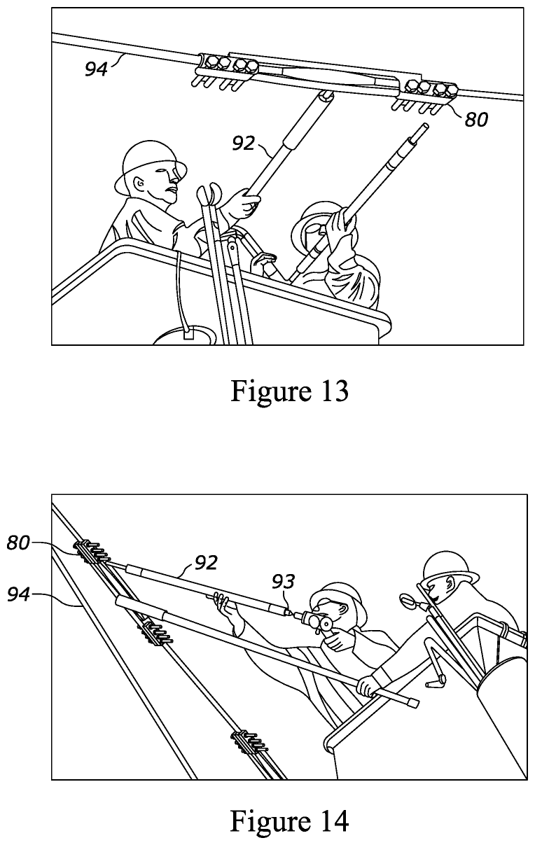

In the embodiment shown, second link member 150 additionally comprises attachment hoop 159 which is welded or otherwise attached and positioned midway between the first and second end sections. Attachment hoop 159 comprises opening 160 which allows for an electrical lineman or technician to position the transmission line repair device 10 on a transmission line 94 using an electrically insulated hotstick 92, as shown in FIG. 13. In some embodiments, the central linking assembly 14 may comprise only one link member, in which case the attachment hoop 159 may be coupled to the sole link member. The linking distance 90 of central linking assembly 14 may vary depending on the application and environment of the device 10.

In the embodiment as shown, the device 10 may be formed from a single or multiple castings that can be joined in any number of different manners. For example, such joining may be achieved through welding or mechanical joining. The frames of the first and second end sections may alternatively be formed through alternate means. It will be understood that the fastener openings can be formed and then tapped so as to have the desired threaded engagement. A fastener may be positioned through each fastener opening and assembled prior to operating device 10.

The first link member 130 is affixed to the entry side of both the first and second end sections at the landing flange 42/242, such that a trough 54/254 is formed between the landing flange 42/242 and first link member. Thus, the outside electrical transmission line can be retained within the troughs so that an operator with a hotstick can manipulate the device 10 while the electrical transmission line can easily be maintained in a stable equilibrium therewithin. Similarly, the second link member 150 is affixed to the clamp side 24/224 of the first and second end sections. This provides additional strength to the coupling of the first and second end sections, and provides a manner by which to grab and retain the device (i.e., through the attachment hoop 159).

Once assembled into the configuration described above, device 10 is ready for use. The device 10 is configured for use in association with existing electrical transmission lines (see, i.e., FIG. 13), and in particular, provides additional mechanical strength and electrical pathways for the electricity passing therethrough. In particular, such a device can be positioned and coupled to the electrical transmission line so as to repair, bypass, reinforce, or otherwise restore electrical and mechanical integrity to a section of the energizeable and/or energized electrical line or conductor. One such application of the current device 10 is in association with “high temperature” electrical connectors in which two high energy and/or high temperature conductors are connected. Further applications of the current repair device include, but are not limited to, electrical line or conductor dead ends, splices, suspensions or otherwise areas where aeolian vibration may cause fatigue. Typical voltages of the line can be in excess of hundreds of thousands of Volts, such as, for example 500 kV, while greater or lesser Voltages are likewise contemplated for the electrical transmission lines. The disclosure is not limited to use in association with any particular voltage or voltage range.

After identifying a section of electrical transmission line to be repaired or otherwise restored of electrical and mechanical integrity, the device 10 is positioned such that the first end section 12 is positioned to one side of the identified section with the second end section 212 positioned on the other side thereof. It is contemplated that device 10 may have various linking distances 90 which will depend on the length of transmission line section to be repaired. Device 10 of the current configuration is positioned by use of an electrically insulated hotstick 92, as shown in FIG. 13. Using hotstick 92, an electrical lineman or technician may maintain a safe distance from energized transmission, distribution, or other electrical wires while positioning the repair device 10. In many instances the device may be positioned from a distance of 8 feet or more, and may be positioned and installed from below the transmission line being repaired, which is often suspended far overhead. In other configurations, the device may be installed from a bucket, helicopter or other elevated structure, again from a distance, preferably. In still other configurations, the attachment may occur when the line is deenergized.

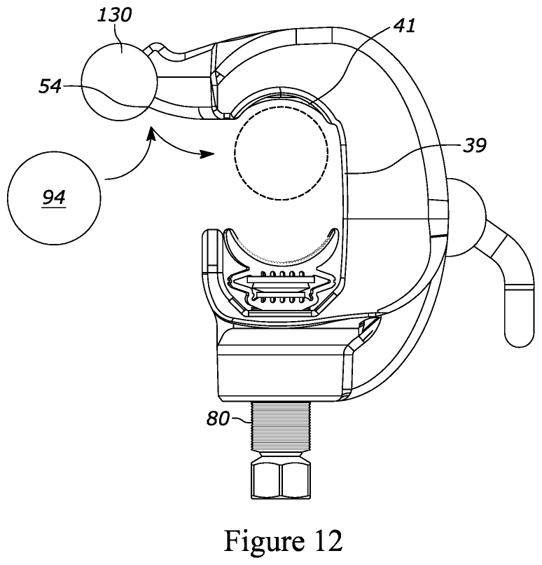

The repair device 10 is directed (for example, with the use of a hotstick, manually, or otherwise) toward the electrical transmission line 94 such that the line 94 corresponds and/or aligns with entrance slots 38,238 of the first and second end sections. In the configuration as shown, it may be easier to first position or rest the line 94 within trough 54/254 before then directing the line through the entrance slots and into throat cavities 32/232, as shown in FIG. 12. At this point transmission line 94 is positioned within the generally curved wire setting surfaces 41/241 of each end section, with the central linking assembly 14 spanning between both. The device may be moved along the transmission line in either direction so as to position in the desired orientation and desired position. It will be understood that the

Once the repair device is properly position with each respective fastener 80 being accessible at the bottom of the device, a lineman or technician may proceed to tighten fasteners 80 to secure the device 10 to the transmission line being repaired. This may be accomplished through the use of a ratchet or through an electrical or pneumatic driver. Such a ratchet or pneumatic driver can be achieved through attachments to the hot stick, such that the fastening can occur while a line is energized. For example, in some configurations, a socket can be mounted to the distal end of the hot stick, coupled to a fastener, and then rotated to tighten (or loosen). In other configurations, a drill or other powered device can be utilized at the end of the hot stick, which drill has the proper ratchet coupled thereto. In still other configurations, the drill can be associated with the proximal end of the hot stick, and the hot stick may be configured to provide a coupling (i.e., as an extension) to the hot stick at the second end thereof. One such configuration is shown in FIG. 14. In FIG. 14, the hotstick 92 is shown as including drill 93 at a proximal end of the hotstick with the distal end having a socket configured to engage with the fastener. As with the positioning, the tightening of the fasteners can occur when the line is deenergized.

In the embodiment as shown, the tightening of fasteners 80 comprises tightening bolts 82 such that the bolts pass through fastener openings 49/249 and into the throat cavities of each first and second end section 12/212 to contact the transmission line 94. As the fasteners continue to be tightened, the fasteners 80 will place increased pressure onto the line 94, and in the embodiment shown, will deform the biasing members 86 of each fastener 80 to create a loaded force exerted on the transmission line. The configuration as shown further comprises the use of breakaway torque limiting screws 88, as disclosed in U.S. Pat. No. 9,689,416, to ensure that the fasteners are tightened to a desired torque and/or torque range.

It will be understood that the fasteners deform the biasing member 86 of the fastener, and also elastically deform the frame of each of the first and second end sections pushing the jaws outwardly, as will be explained in greater detail.

It will be understood that an electrical transmission line, or other energized conductor or device, may continuously operate for extended periods of time at temperatures between −40° to 250° C. Specifically, one of the higher temperature conductors presently available is known as ACSS (Aluminum Conductor-Steel Supported), and is specified by the manufacturer for continuous operation at 250° C. (482° F.). Such conductors have been in use for over 50 years. However, the use and operation of this conductor has been limited because, among other reasons, conventional compression connectors for linking two sections of ACSS line tend to be unable to support such a high temperature over the lifetime of the electrical cable, due in part to physical properties of the materials and more specifically based on the thermal expansion of the dissimilar aluminum and steel materials. Among other uses of the device of the present invention, the device can be utilized to electrically shunt splices and other junctions of such ACSS conductors.

Advantageously, the present transmission line repair device 10 can operate thru a wide range temperatures, namely −40° to 250° C., due to the elastic deformation of the first and second end sections. More specifically, the “C”-shape and rib/valley structure of each end section 12/212 allows frames 30/230 to elastically deform, for example, as the device is subjected to the clamping force of the fasteners 80. In the embodiment shown, the breakaway torque limiting screw 88 may be configured to deflect (i.e., elastically deform) the frame by 60-77% of the elastic range of the material, though it is contemplated that compression forces may be applied outside this range, such as, for example, between 50% and 80%. It will be understood that the deformation may increase and decrease with the temperature of the conductor, and with the understanding that the device remains in the elastic deformation range throughout the operating temperature range (such that the biasing force remains throughout the range of operation). The configuration of the present transmission line repair device is configured to operate at temperatures in excess of 250° C., up to and including 390° C., for example.

The elastic deflection of the frame is opposed by the biasing member 86 of fasteners 80, in this embodiment being the fasteners of U.S. Pat. No. 9,343,823, and this combined resiliency is substantially suitable to maintain the elastic compression force between the fasteners and the transmission line 94. That is as the conductor temperature increases and decreases, there remains an inward biasing force on the conductor that is caused by the elastic deformation of the first and second end sections (which can be opposed by the biasing member of the fastener, when such fasteners are utilized. This ensures that the device and transmission line remain in attachment and relative movement is minimized if not eliminated. Additionally, such intimate contact between the device and the electrical line likewise provides the proper electrical continuity therebetween.

The device operates safely throughout the temperature range of various conductors, including the ACSS conductor relatively higher temperature specifications 250° C. (482° F.). Of course, there is no limitation as to the temperature range for which the present device can be utilized, as the device is also configured to work with aluminum stranded conductors (among other conductive material) at the lower allowable temperatures as prescribed by American National Standard Institute document C119.4. Advantageously, the conductors having the device strategically positioned can be operated at such elevated loading rates and temperatures, whereas in the past, such elevated temperatures have damaged splices and couplings.

Transmission lines are generally designed such that they are not subjected to tensions in excess of 60% of their Rated Break Strength (RBS), the current design of repair device 10 makes it feasible to produce versatile repair devices which are capable of withstanding full tension on the transmission lines being repaired. Said advancements result in part from the elastic resiliency of the design, which allows for the device to adapt and maintain proper compression on the conductor as its tension changes, as well as from the weight and material reductions resulting from the ribbed frame design.

The contours of the outer surface, including the plurality of ribs 46 and channeled fastener shield 60, are designed to shield the exposed ends of the fasteners, and are incorporated to provide an electrical envelope to operate in the “Extra High Voltage” (EHV) range up to 500 kV. Design of said electrical envelope serves to distribute the surface gradient voltage to a level well below the critical value where the formation of electron avalanches occur which result in corona discharge and RIV (Radio Interference Voltage). Therefore, advantageously, additional “shielding” is generally not required.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. An electrical transmission line repair device comprising:
a first end section comprising:
an elongated and electrically conductive frame extending from an inner end to an outer end, and including a clamp side and an entry side opposite the clamp side, the frame forming a C-channel including an upper jaw and lower jaw, the upper and lower jaws being spaced apart from each other to define a throat cavity, with an entrance slot defined on the entry side of the frame, the throat cavity being configured to receive an electrically conductive cable therealong, the lower jaw including a plurality of threaded openings extending therethrough and in communication with the throat cavity; and
a plurality of fasteners threadedly engaged with the threaded openings wherein rotation of the fastener one of inwardly or outwardly directs the fastener toward or away from the upper jaw, and wherein the fasteners are structurally configured to sandwich the electrically conductive cable against the lower jaw, while allowing for elastic deformation of the frame about the clamp side;
a second end section comprising:
an elongated and electrically conductive frame extending from an inner end to an outer end, and including a clamp side and an entry side opposite the clamp side, the frame forming a C-channel including an upper jaw and lower jaw, the upper and lower jaws being spaced apart from each other to define a throat cavity, with an entrance slot defined on the entry side of the frame, the throat cavity being configured to receive an electrically conductive cable therealong, the lower jaw including a plurality of threaded openings extending therethrough and in communication with the throat cavity; and
a plurality of fasteners threadedly engaged with the threaded openings wherein rotation of the fastener one of inwardly or outwardly directs the fastener toward or away from the upper jaw, and wherein the fasteners are structurally configured to sandwich the electrically conductive cable against the lower jaw, while allowing for elastic deformation of the frame about the clamp side; and
at least one electrically conductive link member having a first end and a second end, the first end attached to the first end section, and the second end attached to the second end section so that the first and second end sections are in a spaced apart orientation.

2. The electrical transmission line repair device of claim 1 wherein the frame of the first and second end sections further comprises a plurality of ribs and valleys positioned along the clamping side of both end sections.

3. The electrical transmission line repair device of claim 1 further comprising a fastener shield formed on the bottom side of the frame of both the first and second end sections, the fastener shield including a first sidewall, second sidewall, inner end wall, and outer end wall, all of which collectively form a continuous outer surface, and which define a channel with a fastener bed along the bottom side surface of each frame.

4. The electrical transmission line repair device of claim 3 wherein the lower end of the outer surface of the fastener shield further comprises a lower fillet which creates an inwardly concave and smooth connection surface between the fastener shield and respective frame.

5. The electrical transmission line repair device of claim 3 wherein the fastener shield and frame are integrally formed with the ribs flowing into and being integrally formed with the second sidewall of the fastener shield.

6. The electrical transmission line repair device of claim 1 further comprising a second conductive link member having a first end and a second end, the first end attached to the first end section, and the second end attached to the second end section so that the first and second end sections are in a spaced apart orientation,
wherein the first conductive link member is affixed on the entry side of the first and second end sections, and the second conductive link member is affixed on the clamp side of the first and second end sections.

7. The electrical transmission line repair device of claim 1 wherein each of the frames of the first and second end sections further comprise a landing flange extending from the entry side of the upper jaw.

8. The electrical transmission line repair device of claim 7 wherein one of the at least one link members is affixed to the landing flange of the first and second end sections.

9. The electrical transmission line repair device of claim 8 wherein a trough is formed at the coupling point between the at least one link member and the landing flanges of the first and second end sections.

10. The electrical transmission line repair device of claim 1 wherein one of the at least one link members further comprises an attachment hoop positioned along the length thereof.

11. The electrical transmission line repair device of claim 1 further comprising an entry flange extending from the entry side of the lower jaw of each of the first and second end sections.

12. The electrical transmission line repair device of claim 1 wherein the first and second end sections are substantially mirror images of each other.

13. The electrical transmission line repair device of claim 1 wherein at least some of the plurality of fasteners include a break away portion which breaks away from the fastener when a predetermined torque is reached.

14. The electrical transmission line repair device of claim 13 wherein the break away portion is configured to break away only after the frame has been elastically deformed so as to direct the jaws away from each other.

15. The electrical transmission line repair device of claim 13 wherein the elastic deformation is between 50% and 80%, and more preferably, between 60% and 77% of the elastic range of the first end and second end section.

16. The electrical transmission line repair device of claim 15 wherein each of the plurality of fasteners includes a biasing member so as to be biased against the conductor positionable within the first end section and the second end section.

17. The electrical transmission line repair device of claim 1 wherein the electrically conductive link is one of rigid and flexible.

18. A method of using an electrical transmission line repair device comprising the steps of:
identifying a section of electrical conductor cable to be restored;
providing the transmission line repair device comprising:
a first end section comprising:
an elongated and electrically conductive frame extending from an inner end to an outer end, and including a clamp side and an entry side opposite the clamp side, the frame forming a C-channel including an upper jaw and lower jaw, the upper and lower jaws being spaced apart from each other to define a throat cavity, with an entrance slot defined on the entry side of the frame, the lower jaw including a plurality of threaded openings extending therethrough and in communication with the throat cavity; and
a plurality of fasteners threadedly engaged with the threaded openings wherein rotation of the fastener one of inwardly or outwardly directs the fastener toward or away from the upper jaw;
a second end section comprising:
an elongated and electrically conductive frame extending from an inner end to an outer end, and including a clamp side and an entry side opposite the clamp side, the frame forming a C-channel including an upper jaw and lower jaw, the upper and lower jaws being spaced apart from each other to define a throat cavity, with an entrance slot defined on the entry side of the frame, the lower jaw including a plurality of threaded openings extending therethrough and in communication with the throat cavity; and
a plurality of fasteners threadedly engaged with the threaded openings wherein rotation of the fastener one of inwardly or outwardly directs the fastener toward or away from the upper jaw; and
at least one electrically conductive link member having a first end and a second end, the first end attached to the first end section, and the second end attached to the second end section so that the first and second end sections are in a spaced apart orientation;
directing the cable into the throat cavity of each of the first and second end sections;
tightening the fasteners of the first and second end sections to direct the fasteners toward the upper jaw to sandwich the electrical conductor cable therebetween.

19. The method of claim 18 further comprising the step of:
elastically deforming the first and second end sections through the step of tightening of the fasteners, to between 50% and 80% of the elastic range thereof.

20. The method of claim 18 wherein the transmission line repair device further includes a first trough formed between the first end section and the first link member, and second trough formed between the second end section and the first link member, the method further comprising the step of:
positioning the cable within the first trough; and
positioning the cable within the second trough,
wherein at least one of the steps of positioning occurring prior to the step of directing.
